(19) United States
(12) Patent Application Publication
(10) Pub. No.: US 2019/0347313 A1
(43) Pub. Date: Nov. 14, 2019

(54) METHODS AND SYSTEMS FOR ENRICHING TEXT INFORMATION FOR APPLICATION DATA ENTRY AND VIEWING

(71) Applicant: Noted Analytics, Inc., Boston, MA (US)

(72) Inventors: Matthew M. Walsh, Boston, MA (US); Nicos Vekiarides, Natick, MA (US); Edgar Velazquez, Brooklyn, NY (US); Bryan Chambers, Watertown, MA (US)

(21) Appl. No.: 16/405,176

(22) Filed: May 7, 2019

Related U.S. Application Data
(60) Provisional application No. 62/668,641, filed on May 8, 2018.

(51) Int. Cl. G06F 17/21; G06F 16/35; G06Q 30/00; G06F 3/0482; G06F 17/27; G06F 17/24

(52) U.S. Cl. CPC G06F 17/218; G06F 16/353; G06Q 30/01; G06F 17/243; G06F 17/27; G06F 17/241; G06F 3/0482

(57) ABSTRACT

A note enrichment engine for applying context and structure to unstructured data, such as sales notes, through intelligent metadata tags. Metadata tags are associated with note records manually, or by automatic detection of keywords, or by other language understanding methods. Metadata tags may be configured to initiate events in other systems, such as to populate a database table in a related application such as a Customer Relationship Management (CRM) application, or to create an event in a calendar application, or to provide a taxonomy for note search and later retrieval.

### CROSS-REFERENCE TO RELATED APPLICATION

This application claims the benefit of U.S. Provisional Application No. 62/668,641, filed on May 8, 2018. The entire teachings of the above application is incorporated herein by reference.

### TECHNICAL FIELD

This application relates to extracting information from unstructured data sources such as text, and more particularly to enriching text information for entry into related applications such as Customer Relationship Manager (CRM) applications.

### BACKGROUND

Every customer interaction is an opportunity to capture valuable information that organizations can use to improve their products, services, and internal processes. Customers share their frustrations, concerns, goals, and way in which they want to work with a vendor or service provider. However, most of this information is stored in an unstructured data source like a word processing application and does not find its way into a customer relationship management system (CRM).

Studies have shown that for example, only about five percent (5%) of the information exchanged during sales meetings actually makes it into CRM systems. This is due to the somewhat lengthy workflow to update CRM systems. The typical sales person first takes notes with a word processing application. They then login to the CRM application, navigate to the appropriate activity section and add their notes. They may then have to update or fill-out additional fields, sometimes as many as a dozen or more entries, followed by updating tables. Therefore, maintaining current information is a manual and time consuming process, with the average user now spending more than six (6) hours per week making these updates.

An opportunity therefore arises for a platform to allow users to freely capture customer engagements in a way that enriches the information for the purposes of automatic data entry into CRM systems. An opportunity also arises to share suggestions to the platform user based on the context of the current customer interaction and the history of previous interactions. An increased amount of information on customer interactions, reduced time spent on CRM data entry, and improved customer satisfaction may therefore result.

### SUMMARY

Intelligent Metadata for Sales Notes

Described herein are methods, systems and computer programs for applying context and structure to sales notes through intelligent metadata tags. Note records may be initially created with a word processing application and stored as individual, sentence-like entities. A note record can have one or more metadata tags assigned to it, either manually, or by automatic detection of keywords. In some implementations, language understanding algorithms may be applied to the sentence structure in the note records to determine possible related metadata tags. Metadata tags may be configured to initiate certain activities, such as to populate a database table in related business applications such as a Customer Relationship Management (CRM) application, or to create an event in a calendar application, or to provide a taxonomy for note search and later retrieval. The user can, in some implementations, manually choose from a list of available preconfigured metadata tags such as ‘Attendee’, ‘Challenge’, ‘Next Step’, and ‘Champion’ or may create their own.

In one embodiment the method or apparatus involves displaying a text note region and a tag region. Metadata tags are automatically assigned to notes entered into the text note region, such as by analyzing them for keywords. However, metadata tags can also be assigned to the note in other ways, such as manually, or by more sophisticated language processing. The notes are then fed to another application, such as a CRM application, along with the detected metadata tags, which may in turn initiate some action in the CRM application.

Prescriptive Insights Based on Sales Notes

Also described are methods, systems and computer programs for delivering prescriptive insight information, such as suggestions, guidance, or recommendations, to a user based on notes taken and/or historical actions performed by the user or other members of the user's team. A pattern may be extracted from a collection of note records and metadata tags. For example, a pattern may be extracted that many “Manufacturing” customers that use “Software X” struggle when creating new reports. A user may see a message box with an insight, a text description of the pattern, such as “Since this Manufacturing customer uses SoftwareX, ask if they are struggling with reporting?” Users may approve or reject an insight, creating a feedback loop that improves the ability of the system to detect patterns and suggest future insights.

Accordingly, in one embodiment, a method or apparatus may include displaying a text note region that is used to input information related to sales activity. Detected input may then cause one or more automated actions related to sales insights, including displaying an alert to the user of a new sales insight; accepting text input from the user related to a sales insight and storing the text into a record representing a meeting or other activity as a note; or accept or rejecting text input as a sales insight.

### BRIEF DESCRIPTION OF THE DRAWINGS

In the following drawings like reference numbers are used to refer to like elements. Although the following figures depict various examples, one or more implementations are not limited to the examples depicted in the figures.

FIG. 1 is a block diagram illustrating a representative data flow system for providing user entered information into a note enrichment data repository and a third party party business application database.

FIG. 2 is a diagram illustrating the GUI layout for an online note-enrichment application.

FIG. 3 is a GUI screen shot for an online application used for capturing information in a sales meeting.

FIG. 4 is a GUI screen shot of the application in a state that allows multiple notes to be selected (e.g., multi-select mode).

FIG. 5 is a GUI screen shot displaying a list of suggested metadata tags based on user input.

FIG. 6 is a GUI screen shot illustrating how a metadata tag can be applied to a selection of notes in multi-select mode.

FIG. 7 is a GUI screen shot illustrating how a metadata tag can be automatically applied to a note.

FIG. 8 is a GUI screen shot of a user or team sourced sales insight.

FIG. 9 illustrates the GUI of the note-enrichment application in a state that allows the user to view text data from third party sources.

FIG. 10 is a diagram a GUI screen shot of third party data, like an email.

FIG. 11 is a GUI screen shot of a web browser displaying an email.

FIG. 12 is a GUI screen shot of the system available to users as a browser extension.

FIG. 13 illustrates one implementation of a note record schema is

FIG. 14 is a flowchart of one implementation of creating note record information during a customer interaction and updating CRM.

FIG. 15 is a flowchart of one implementation of the user seeing a prescriptive insight based on the context of the current customer interaction.

### DETAILED DESCRIPTION OF A PREFERRED EMBODIMENT

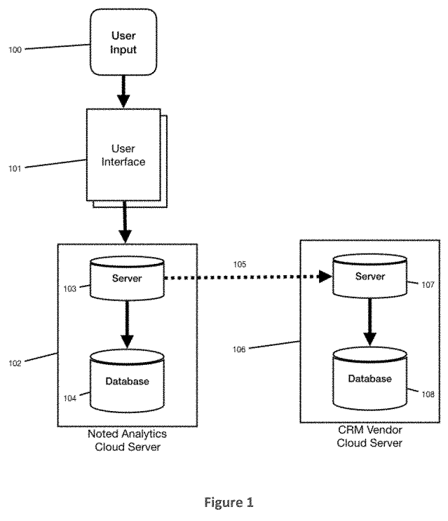

Turning attention now to the drawings in more detail, FIG. 1 is a block diagram illustrating a representative data flow for providing information into a note enrichment engine application. In one scenario, the user interacts 100 with an online application user interface 101 being served from the note enrichment referred to in this embodiment as the Noted Analytics Cloud Platform 102, which in turn includes a Noted Analytics server 103 and Noted Analytics database 104. Information is passed from the online application user interface 101 to the Noted Analytics server 103 which further process the information and stores it in the Noted Analytics database 104. In another approach, A user may also push meeting notes into a Customer Relationship Management (CRM) system 106 through a CRM Application Program Interface (API) 105. In that case, the data is passed to the CRM server 107 and the data is stored in the CRM database 108.

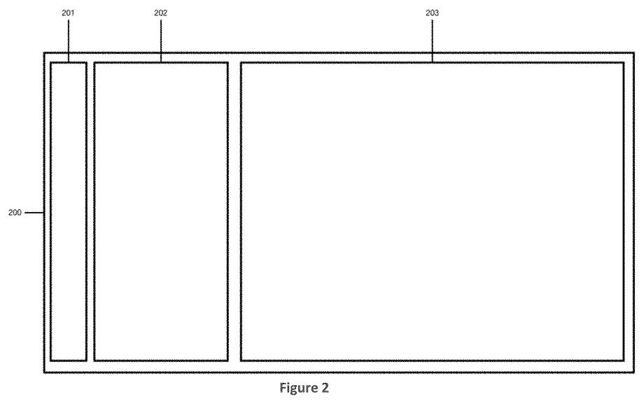

FIG. 2 is a diagram illustrating the Graphical User Interface (GUI) layout for the note enrichment engine. The user interface screen 200 may include a primary navigation area 201 to access different components of the application. Selecting an element in primary navigation area 201 may update the content displayed in the secondary navigation area 202. Selecting an element in secondary navigation area 202 may update the content displayed in an application workspace 203.

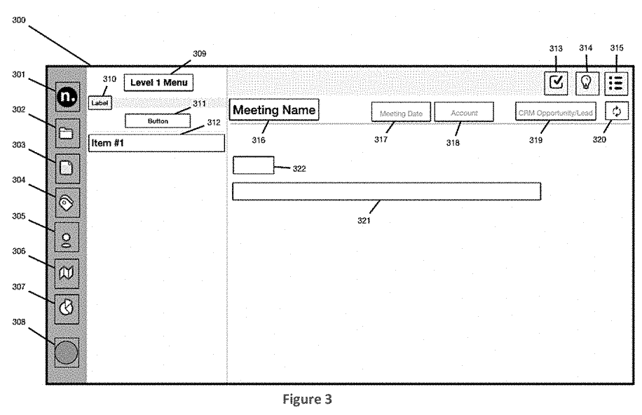

More particularly, FIG. 3 is an example GUI screen shot used for capturing information in a sales meeting. Icons in the primary navigation area as described in FIG. 2 may allow the user to access, for example, a home application page 301, list of accounts 302, list of meetings 303, list of metadata tags 304, list of contacts 305, list of interactive stories 306, list of reports 307, and/or user profile settings 308. An example secondary navigation area as was mentioned in FIG. 2 may contain a label 309, secondary label 310, action button 311, and list of selectable items 312. The example application workspace as was mentioned in FIG. 2 may display functional buttons to show a list of tasks 313, insights 314, and an option to allow multiple notes to be selected at once 315. The meeting name may be displayed and can be edited 316 and the meeting date is displayed and can be edited 317. The meeting can be linked to a CRM account 318, CRM lead or opportunity 319. Meeting note information is pushed to CRM by selecting on the sync button 320. Meeting notes are entered and displayed 321 next to any associated metadata tag 322 are displayed.

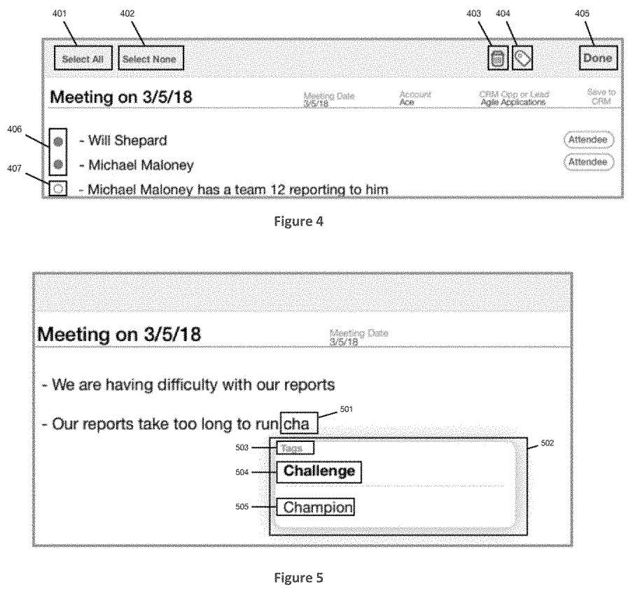

FIG. 4 is a GUI screen shot of the example note enrichment application in a state that allows multiple notes to be selected (e.g., multi-select mode). Here the user has entered notes from a meeting held on Mar. 5, 2018. All notes can be selected with a button 401 or deselected with a button 402. Individual notes can be also selected by the user. Selected notes may appear with a dark circle next to them 406 and unselected notes may appear with a hollow circle next to them 407. Selected notes can be deleted 403 and assigned a metadata tag 404. Once activated, the multi-select mode is enabled until the user selects on the ‘Done’ button 405.

FIG. 5 is a GUI screen shot displaying a list of suggested metadata tags based on user input. The current text being typed 501 may trigger a popup window 502 with a label 503 describing the information displayed. The user selects a metadata tag to add it to a note. Here the text entered as meeting notes, e.g., “We are having difficulty” and “Our reports take too long to run” has prompted the user to also input a suggested metadata tag, e.g., “Challenge”. An item that appears in a bold font such as at 504 may be selected by the user by hitting the return key. All other items may appear in a regular font 505.

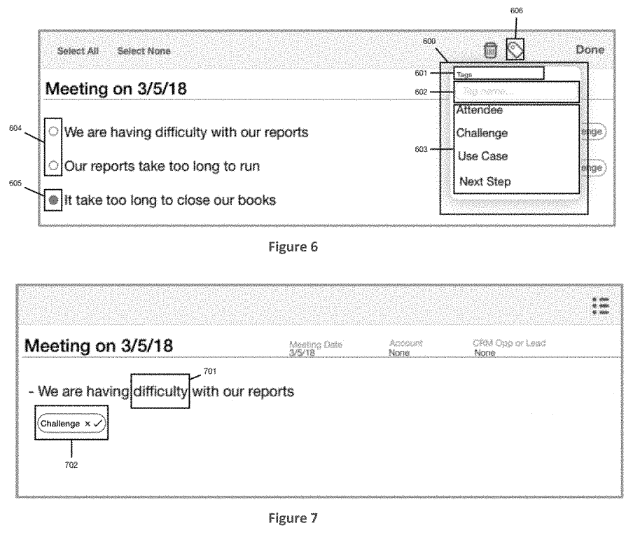

FIG. 6 is a GUI screen shot illustrating how a metadata tag can be applied to a selection of notes in multi-select mode. A user selects the metadata button 606 to view a popup window 600 with a label 601, a component to search for existing metadata tags 602, and a list of metadata tags 603. Pressing a metadata tag adds it to the selected notes 605 and does not change unselected notes 604.

FIG. 7 is a GUI screen shot illustrating how a metadata tag can be automatically applied to a note. Certain keywords 701 may trigger a note to have a metadata tag 702 be automatically tagged based on a natural language processing and machine learning algorithm. The algorithm is designed to identify patterns in text that is associated with a metadata tag. In this example, the algorithm may have detected the word “difficulty” and informed the system to prompt a “Challenge” tag. The suggested tag can be accepted or rejected by the user by click on the “X” or “✓”. Selecting on the accept or reject button may generate additional data as a part of a feedback loop to improves the system's ability to identify and suggest metadata tags. The feedback can be specific to each user, the context (e.g., the type of customer which the user is interacting with), or the user's organization.

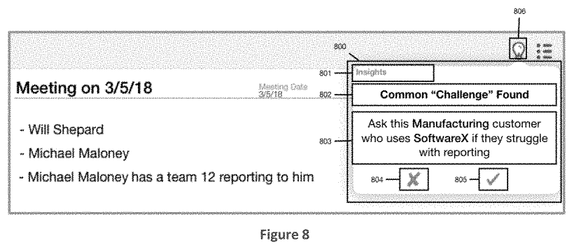

FIG. 8 is a GUI screen shot of a user or team sourced sales insight. The insight button 806 may be highlighted to visually indicate the availability of an insight that is related to the text input or previously entered or detected metadata tag. In this example, the “Challenge” metadata tag has a related insight 803. To ask this particular Manufacturing customer if they are struggling when using a particular piece of software. Selecting the insight button 806 launches a popup window 800 that may contain a label 801, a title for the insight 802, a detailed description of the insight 803, and a button to reject 804 or approve 805 the insight. Selecting on the accept or reject button may generate data as a part of a feedback loop to improves the system's identification and suggestion of insights. Approving the insight, for example, may result in importing the insight detail into the meeting as a note record.

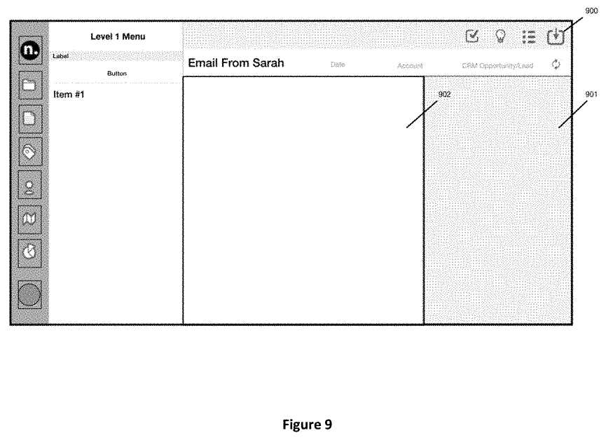

FIG. 9 is a diagram illustrating the GUI of the note-taking application in a state that allows the user to view text data from third party sources, such as a word processing application, business application, web page, email message, or voice transcription. The window to view the text data may be opened and closed by clicking on a button 900. The text information would appear as a window 901 adjacent to the window where meeting notes are taken 902.

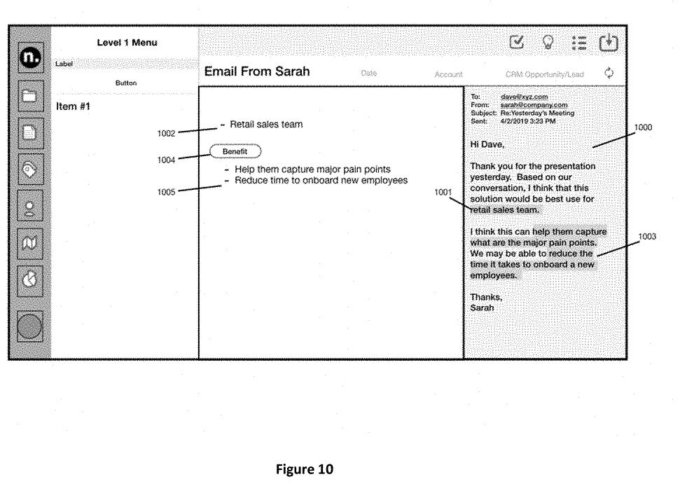

FIG. 10 is a GUI screen shot of how third party data, like an email, may be displayed 1000. The user may select specific text 1001 that may be brought into the note editor as a note record 1002. Other lines of text may be selected 1003 to create note records 1005 with one or more metadata tags 1004. The system may learn from the user so that this process of creating note records and assigning metadata tags can be automated. This activity allows the system to detect and therefore understand patterns of notes records and associated metadata tags that are created from the displayed text. Continued use of the system allows these note records and metadata tags to then subsequently be automatically generated based on the existence of similar text. The user benefits from having only the key pieces of information from an email or other data source to be extracted, categorized, and updated in a business application like CRM.

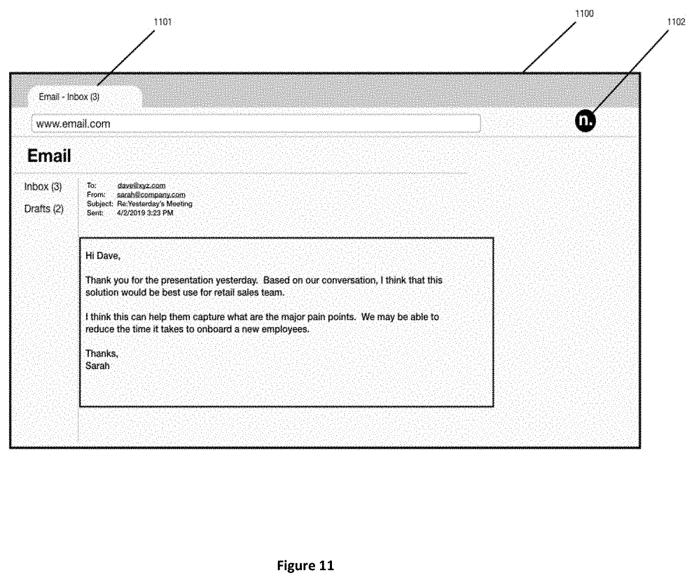

FIG. 11 is a GUI screen shot of a web browser 1100 displaying the content of a website, in this case, an email application 1101. The system to create note records with links one or more metadata tags may be available to the user as a browser extension 1102 available through third party marketplaces like the Google Chrome Webstore. Otherwise, the Noted Analytics system operates as for the dedicated application described above.

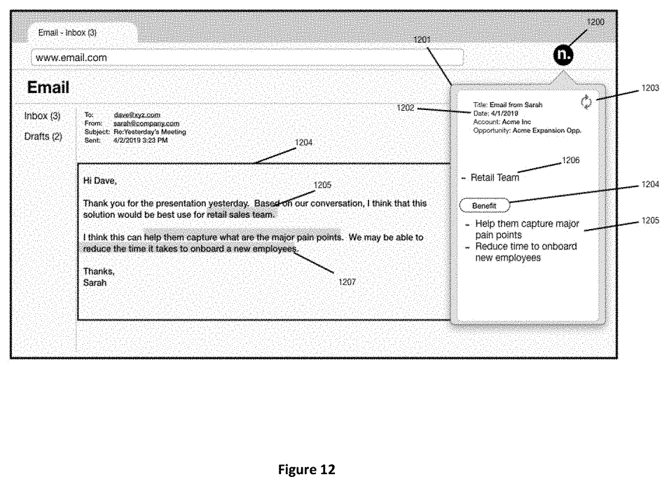

FIG. 12 is a GUI screen shot of the system available to users as a browser extension and may be initiated when a user selects an icon 1200. A small window 1201 may appear and may allow the user to specify information 1202 about the collection of note records captured. Note records information may be pushed to CRM or other initiate other workflows by pressing a button 1203. Text areas 1204 in the web browser may be available for the user to select. Selecting text 1205 may create a note record 1206. Other text selections 1207 may create note records 1208 that can be linked to one or more metadata tags 1209. Otherwise, the Noted Analytics system operates as for the dedicated application

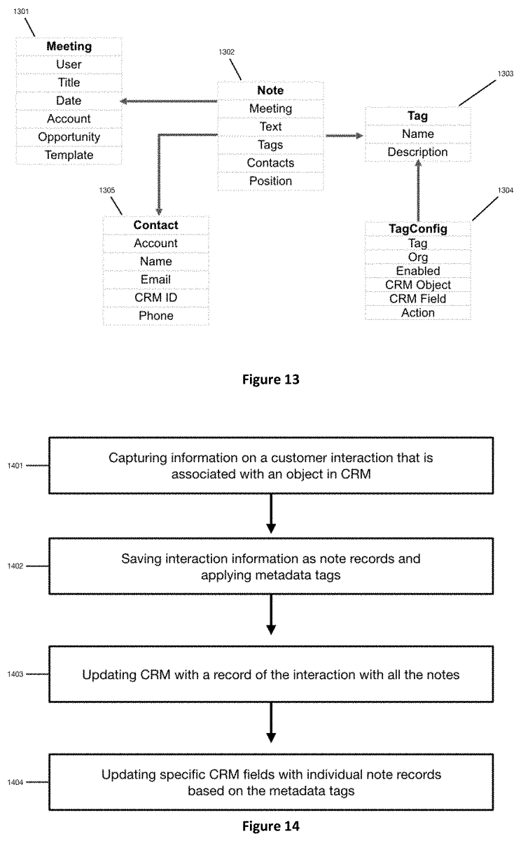

FIG. 13 illustrates one implementation of a note record schema 1300 that can be used to store customer interaction data. This and other data structure descriptions in this illustration shown as objects can be also implemented as tables that store multiple records or object types. This illustration is for explanation purposes and is not as a limitation on the structure implementation. Item 1301 represents a meeting object, and 1302 represents a note object. A note object 1302 may have one or more metadata tag objects 1303 and a metadata tag object may have one or more metadata tag configuration objects 1304. A note object may also have one or more contact objects 1305.

In this example, a meeting object 1301 may be associated with objects in CRM like an account or opportunity. A meeting object will include at least one note object 1302. A note object 1302 may contain one or more sentences, and/or reference one or more contacts 1305 in CRM, and be linked to one or more metadata tag objects 1303. The position field of a note record dictates the order in which it is displayed amongst the other notes in a meeting. Metadata tag objects 1303 are a list of dictionary words used in sales conversations like “Challenge”, “Solution”, and “Next Step” or can be an acronym like “HIPPO” for “the highest paid person's opinion”. From the list of metadata tags, some implementations will choose a subset of tags to be made available for the users. A metadata tag config object 1304 dictates which fields are available (i.e., via the “Enabled” field) for a given implementation (i.e., via the “Org” field). Each implementation may decide which CRM Objects and CRM fields should be updated, either by overwriting the existing value or adding new text at the end of the existing text (i.e., via the “Action” field). In other implementations, the note record schema may not necessarily have the same exact objects, tables, fields or entities as those listed above.

FIG. 14 is a flowchart 1400 of one implementation of a process for creating note record information during a customer interaction and updating CRM. At Action 1401, information is captured during customer interactions. In some implementations, the subject of the customer interactions will be represented in CRM as an account, opportunity, contact, or other objects. Information may be captured by but is not limited to an alphanumeric input device (e.g., a keyboard), a user interface cursor controller (e.g., a mouse), voice, or electronic message (e.g., email).

At Action 1402, information captured during the customer interaction is broken down into note records. An example of a note record is, “The company is using SoftwareX. It is not working well”. This note record would have two metadata tags linked to it like “System”, due to the mention of “SoftwareX”, and “Challenge” due to the mention that “it is not working well”. Metadata tags can be applied to a note record in various ways that include but are not limited to typing the name of the tag with a keyboard and selecting the tag with a mouse. Tags may also be automatically assigned by the system by an algorithm based on the historical pattern of similar note tags having that tag based. Examples of algorithm generation and note text like cleaning techniques include cleaning, stemming, building an inverse document frequency, and use of support vector machines and neural networks.

At Action 1403, note records from a customer interaction are pushed to CRM to update an account, opportunity, contact, or other object. In some implementations, this may be in the form of a task or activity being created and associated with a CRM object. The contents of the task or activity would include the note records of the interaction. At Action 1404, additional tables and specific fields in the CRM system may be updated based on the presence of metadata tags. Metadata tags are configured to overwrite or append the field or table with the note record text and can be mapped to one or more fields or tables in CRM.

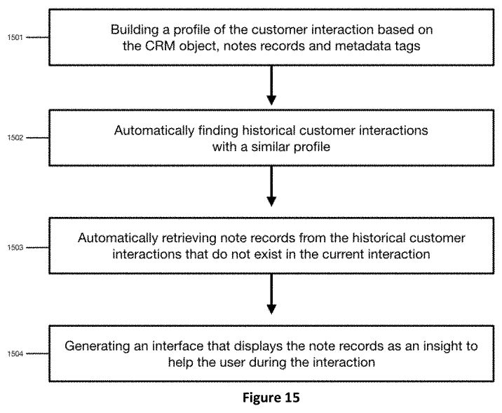

FIG. 15 is a flowchart 1500 of one implementation of the user seeing a prescriptive insight based on the context of the current customer interaction. Action 1501 represents the process of building a customer interaction profile based on associated CRM objects, note records, and metadata tags. Attributes of this interaction profile include the number of previous interactions, account industry, account size, names and roles of contacts engaged, discussed challenges, and proposed solutions amongst other details. The list of profile attributes above is by way of example only, and is not a limitation on the profile structure.

At Action 1502, the current customer interaction profile is used to identify historical customer interactions with a similar profile (e.g., build a propensity score). Examples of propensity score building techniques include sentiment analysis, linear and logistic regression, classification, support vector machines, decision trees, and neural networks. At Action 1503, note records of potential interest are identified by comparing notes records and metadata tags between the current and historical customer interactions with a high propensity score.

At Action 1504, potential notes of interest are displayed through a graphical to support the user during the current customer interaction. The interface shares information on why the note is being displayed and offers the user the ability to accept and reject the message.

The foregoing description of example embodiments provides illustration and description of systems and methods for providing context and structure for analyzing notes to provide intelligent metadata tags to augment applications, such as Customer Relationship Management (CRM) systems, but is not intended to be exhaustive or to be limited to the precise form disclosed.

For example, it should be understood that the embodiments described above may be implemented for applications other than CRM applications.

The implementation details may also take many different forms. In some instances, the various “data processing systems” described herein may each be implemented by a separate or shared, physical or virtual, general purpose computer having a central processor, memory, disk or other persistent mass storage that store software instructions. These systems may include communication interface(s), input/output (I/O) device(s), and other peripherals. The general purpose computer is transformed into the processors with improved functionality, and executes the processes described above to provide improved operations. The processors may operate, for example, by loading software instructions into a non-transitory storage device, and then executing the instructions to carry out the functions described.

Embodiments may therefore typically be implemented in hardware, firmware, software, or any combination thereof. In some implementations, the computers that execute the processes described above may be deployed in a cloud computing arrangement that makes available one or more physical and/or virtual data processing machines via a convenient, on-demand network access model to a shared pool of configurable computing resources (e.g., networks, servers, storage, applications, and services) that can be rapidly provisioned and released with minimal management effort or service provider interaction. Such cloud computing deployments are relevant and typically preferred as they allow multiple users to access computing. By aggregating demand from multiple users in central locations, cloud computing environments can be built in data centers that use the best and newest technology, located in the sustainable and/or centralized locations and designed to achieve the greatest per-unit efficiency possible. Furthermore, firmware, software, routines, or instructions may be described herein as performing certain actions and/or functions. However, it should be appreciated that such descriptions contained herein are merely for convenience and that such actions in fact result from computing devices, processors, controllers, or other devices executing the firmware, software, routines, instructions, etc.

It also should be understood that the block and flow diagrams may include more or fewer elements, be arranged differently, or be represented differently. It further should be understood that certain implementations may dictate the block and flow diagrams and the number of diagrams illustrating the execution of the embodiments be implemented in a particular way.

Other modifications and variations are possible in light of the above teachings. For example, while a series of steps has been described above with respect to the flow diagrams, the order of the steps may be modified in other implementations. In addition, the steps, operations, and steps may be performed by additional or other modules or entities, which may be combined or separated to form other modules or entities. For example, while a series of steps has been described with regard to certain figures, the order of the steps may be modified in other implementations consistent with the principles of the invention. Further, non-dependent steps may be performed in parallel. Further, disclosed implementations may not be limited to any specific combination of hardware.

Certain portions may be implemented as “logic” that performs one or more functions. This logic may include hardware, such as hardwired logic, an application-specific integrated circuit, a field programmable gate array, a microprocessor, software, wetware, or a combination of hardware and software. Some or all of the logic may be stored in one or more tangible non-transitory computer-readable storage media and may include computer-executable instructions that may be executed by a computer or data processing system. The computer-executable instructions may include instructions that implement one or more embodiments described herein. The tangible non-transitory computer-readable storage media may be volatile or non-volatile and may include, for example, flash memories, dynamic memories, removable disks, and non-removable disks.

Also, the term “user”, as used herein, is intended to be broadly interpreted to include, for example, a computer or data processing system or a human user of a computer or data processing system, unless otherwise stated.

It will thus be apparent that other variations and modifications may be made to the described embodiments, with the attainment of some or all of their advantages. Therefore, it is the object of the appended claims to cover all such variations and modifications as come within the true spirit and scope of the disclosure and their equivalents.

### Further Considerations

### Intelligent Metadata for Sales Notes

Methods, systems and computer programs for using sales terminology as metadata tags, may comprise:
   A visual display of the metadata tag in the software application through the use of an outline hierarchy and association to note records underneath that hierarchy node.
   A method to link one or more tags to sales note records by:
      Using keyword detection to show and select a tag from a filtered list.
      Using keyword detection to automatically assign a specific tag.
      Using artificial intelligence to automatically assign a specific tag.
      Selecting multiple sales notes and applying a metadata tag.
   A method to remove a metadata tag from a sales note record.
   A method to train the system to automatically associate metadata tags to a note record.
   A visual display to create note records and associated metadata tags by selecting text displayed in a 3^{rd} party application or browser.
   A series of structured views to display sales notes based on characteristics like:
      Timestamp
      CRM lead, CRM lead status, CRM opportunity, CRM opportunity stage, CRM account, CRM task, CRM contact
      Metadata tag (e.g., Pain, Next Steps)
      User Role (e.g., account executive, sales manager, marketer)
   A mechanism to trigger an event or series of events that include but is not limited to:
      Populating a database table in business applications like Customer Relationship Management (CRM)
      Creating an event in a calendar application
      Creating a task or workflow in a business application like CRM
      Sending an alert or notification
      Popping up a graphical display listing auto-complete text options
   A method to generate note records based on selected text from a 3r^{d} party system that includes but is not limited to:
      word processing application
      business application
      web page
      web application
      email client

### Prescriptive Insights Based on Sales Notes

Methods, systems and computer programs for a feedback and enablement application, may comprise:
   A delivery mechanism to share sales insights with the user that include, but is not limited to:
      A methodology for displaying sales insights, including:
         A UI element to alert the user of a new insight
         A UI element that shows the details of a sales insight
         4A UI element that enables the user to:
         accept the insight and import the text into the meeting as a note
         accept or reject the insight and record the activity as a part of a feedback loop to strengthen the suggestion algorithm with additional relevancy data
      An artificial intelligence smart bot that is able to receive user messages and returns appropriate responses
      An email message that is sent daily, weekly, or monthly to summarize user activity and share relevant information
      A voice-enabled assistant to speak queries and hear audible responses
      An SMS text messaging system that is able to receive user messages and returns appropriate responses
   A repository of sales insights and suggestions made up of:
      General sales best practices with wide applicability
      Company best practices based on prior successful sales team performance and behavior
      User-generated suggestions
      Marketplace for premium content suggestions by 3^{rd} party vendors and industry thought leaders
   An algorithm that analyzes the notes records and sales insight/suggestions using a scoring system based on:
      Note content
      Metadata tags
      CRM account characteristics (e.g., industry, account revenue, number of employees)
      Properties of the associated CRM opportunity or lead record
         Product being sold
         Stage of sales opportunity
         Status of the lead
         Number of open tasks

1. A method comprising:
at a device with one or more processors, non-transitory memory, input device, and a display, the method comprising the steps of:
displaying, on the display, a text note region;
detecting, on the input device, an indication of an input note; and
in response to detecting the input note within the text note region:
associating a metadata tag with the input note by:
accepting further user input selecting select a metadata tag from a list in the tag region;
detecting one or more keywords in the further user input to automatically assign a metadata tag to the input note; or
oherwise analyzing the input note to automatically assign a metadata tag; and
forwarding the text note and the metadata tag to another application program.

2. The method of claim 1 additionally comprising:
detecting selection of multiple input notes within the text region and associating a metadata tag to each such input note.

3. The method of claim 1 wherein the text note region is part of a sales-related application and the metadata tags are at least one of a timestamp, Customer Relationship Manager (CRM) lead, CRM lead status, CRM opportunity, CRM opportunity stage, CRM account, CRM task, CRM contact, Pain, Next Steps, User Role including account executive, sales manager, or marketer.

4. The method of claim 1 additionally comprising:
triggering at least one event based on the metatag including one or more of:
auto-populating a specific field in a Customer Relationship Manager (CRM) application;
creating a task or workflow in a CRM application;
sending an alert or notification; or
displaying a list of auto-complete options.

4. A method comprising:
at a device with one or more processors, non-transitory memory, input device, and a display, a method comprising the steps of:
displaying, on the display, a sales note region;
detecting, on the input device, an input within the sales note region; and
in response to detecting the input within the sales note region, one or more of:
displaying an alert to the user of a new sales insight;
displaying details of a related sales insight;
accepting text input from the user related to a sales insight and storing the text into a record representing a meeting or other activity as a note; or
accept or rejecting text input as a sales insight.

5. The method of claim 4 comprising additional steps of associating the text input with one or more of:
an activity which is related to a sales activity suggestion application;
a repository of sales insights comprising one or more of:
general sales best practices;
company best practices based on prior successful sales team performance and behavior;
user-generated suggestions;
a marketplace for premium content suggestions; or
an algorithm that analyzes the sales notes and associated sales insights using a scoring system based on:
note content
metadata tags
CRM account characteristics including industry, account revenue, or number of employees; or
properties of an associated CRM opportunity or lead record including product being sold, stage of sales opportunity, the status of the lead, or number of open tasks.

6. The method of claim 1 additionally comprising one or more of:
adding all notes that are associated with a meeting, either individually or as a group;
adding all notes belonging to a metadata tag; or
exclude specific notes or notes with metadata tags based on defined rules.

7. The method of claim 6 additionally comprising:
presenting a user interface element for adding or removing sales note records.

8. The method of claim 7 wherein the user interface element additionally:
includes structured views that display notes as:
a detailed listing of meetings over a span of time;
an executive summary; or
a summary of shared content and attachments.

9. The method of claim 1 wherein a user interface element additionally provides one or more of
a methodology to access a related application with:
a unique, non-searchable URL with time limits;
an ability to add additional collaborators;
an option to put access controls on additional users; or
a hyperlink embedded in a summary email; or
a methodology to interact with a related application by:
adding comments or feedback; or
approving information through an icon or button; or
a methodology to track and record application activities including:
number of times accessed; or
content accessed; or
meetings viewed; or
comments or feedback created; or
approvals of information through an icon or button
